(19) United States
(12) Patent Application Publication
(10) Pub. No.: US 2025/0135908 A1
(43) Pub. Date: May 1, 2025

(54) ELECTRIC POWERED TOWABLE HABITAT

(71) Applicant: Mobius RV, LLC, Miami, FL (US)

(72) Inventor: Kirk Hawkins, Redondo Beach, CA (US)

(21) Appl. No.: 18/488,777

(22) Filed: Oct. 17, 2023

(51) Int. Cl. B60L 15/20; B62D 59/04

(52) U.S. Cl. CPC B60L 15/2045; B62D 59/04; B60L 2240/423; B60L 2240/60

(57) ABSTRACT

Electric motors in a towable habitat are controlled through a combination of electronic control systems/controller, sensors, and power management protocols. The control mechanisms are designed to manage the power supplied to the electric motors thereby controlling torque delivered to each wheel and control wheel speed while ensuring efficient and safe operation.

### RELATED APPLICATION

The present application relates to and claims the benefit of priority to U.S. Provisional Patent Application No. 63/380,010 filed Oct. 18, 2022, which is hereby incorporated by reference in its entirety for all purposes as if fully set forth herein.

### BACKGROUND OF THE INVENTION

### Field of the Invention

Embodiments of the present invention relate to devices and systems comprising electric powered towable habitats and more particularly to mobile habitats for living, working, or recreational purposes having electric motors.

### Relevant Background

There is an ever-increasing consumer shift toward mobile, flexible lifestyles. Advances in technology have made it possible for much of the workforce to work remotely now. Given these disruptive societal changes combined with other consumer movements such as sustainable living, electric mobility, solar power, and minimalism, there has been a rapidly increasing demand for advanced towable mobile habitats that integrate advanced technologies into structural platforms that can serve the multiple functionalities of living, working or recreation. Such towable habitats include but are not limited to mobile auxiliary dwellings units, mobile office units, or recreational vehicles.

Current recreational vehicles (RVs) and travel trailers lag in technological development and are currently ill-suited for the growing market of advanced mobile living structures. This limits their use for many applications. For example, they do not carry their own power or propulsion system and thereby severely limit range when they are paired with an electric vehicle (EV). Existing RVs lack energy regeneration, power management, and stability control systems, making them less safe and entirely reliant on the tow vehicle's ability to pull and control them, requiring, in many instances, a dedicated tow vehicle depending on the size and scope of the towable of choice. Existing trailers can be difficult to connect, tow, and park, requiring high levels of user competency to ensure safe use.

Associating electric motors with wheels in towable vehicles is an emerging area of innovation within the realm of electric mobility embraced by electric vehicles. Electric motors can enhance the functionality and efficiency of towable vehicles and the like, providing benefits like increased towing capacity, improved maneuverability, reduced fuel consumption, and lower emissions compared to traditional towable vehicles. Yet the incorporation of electric motors in towable vehicles is not without its challenges, which include technological, logistical, and practical aspects.

One of the needs of consumers that is lacking in the prior art is the ability to adapt an electrically equipped towable vehicles to provide a variable amount of power assistance depending on multiple factors including for example, the tow vehicle capability, length of trip, altitude gain of the route, and availability of power at the destination. All towing vehicles are not the same, each having differing capabilities. Similarly, the use of recreational trailers varies widely. In one instance a user may take their trailer to a trailer park with substantial amenities designed to support an RV with easy access to and from the location as well ability to park the trailer in a designated location. In other instances, the user may elect to camp off the grid in locations, which are austere and require a more self-sufficiency mindset. Matching travel plans with the capabilities of the tow vehicle and the towable vehicle is a complex challenge.

Integrating an electric towable habitat system with various types of towing vehicles, including both traditional internal combustion engine (ICE) vehicles and electric vehicles (EVs), can be complex. Compatibility and communications between the towing vehicle's powertrain and the towable's electric system need to be ensured even when there is no direct communication link between the towing vehicle and the towable. These and other deficiencies of the prior art are addressed by one or more embodiments of the present invention.

Additional advantages and novel features of this invention shall be set forth in part in the description that follows, and in part will become apparent to those skilled in the art upon examination of the following specification or may be learned by the practice of the invention. The advantages of the invention may be realized and attained by means of the instrumentalities, combinations, compositions, and methods particularly pointed out in the appended claims.

### SUMMARY OF THE INVENTION

An electrically powered towable habitat is controlled through a combination of an electronic control systems/controller, sensors, and power management protocols. The controls manage the power supplied to the electric motors thereby controlling torque delivered to each wheel and wheel speed while ensuring efficient and safe operation.

In one embodiment of the present invention an electric powered towable habitat includes a frame having two or more wheels with at least one wheel positioned on each side of the frame. At least one wheel on each side of the habitat is associated with a unique electric motor. The towable habitat also includes a hitch assembly configured to couple the towable habitat to a towing vehicle, and at least one sensor configured to gather sensor data. A power source is included for providing electrical power to each unique electric motor along with a controller communicatively coupled with each electric motor and each sensor. The controller is configured to receive sensor data from each sensor and use that data to generate independent torque commands for each unique electric motor based on the sensor data and one or more power management protocols.

In one version of the present invention the power management protocol is configured to provide independent torque commands to each unique electric motor based on a distance to destination input. In another version of the present invention, the power management protocol is configured to provide independent torque commands to each unique electric motor based on a residual power at destination requirement, the amount of solar power being absorbed, or some other user set designated power level. And in yet another version the power management protocol is configured to provide independent torque commands to each unique electric motor based on predetermined torque limits or to provide independent torque commands to each unique electric motor based on sensor data indicative of a towable habitat inclination and towable habitat weight.

Sensors contemplated in the present invention can collect geo-positional data, force data, and/or positional data. Using that data, the power management protocol is configured to provide independent torque commands to each unique electric motor based on an elevation gain or loss over a prescribed travel route and to modify each unique electric motor between a torque generation mode and a regenerative mode. In another version of the present invention at least one sensor is an optical sensor that provides relative positional data between the towable habitat and towing vehicle. The invention can also include a datum movement sensor that identifies relative deviations measurements of movement between the towable habitat and towing vehicle.

Another aspect of the present invention is a method for propelling a towable habitat using electric motors. The method includes positioning at least one wheel on each side of the towable habitat and associating each of the at least one wheel with at least one unique electric motor. The towable habitat is further coupled to a towing vehicle with sensors gathering sensor data. The method continues by providing, by a power source, electrical power to the at least one unique electric motor and to a controller. The controller is communicatively coupled with each electric motor and sensors. And upon receiving sensor data from each sensor as well as a power management protocol, the controller generates independent torque commands for each motor.

Other features of a method for propelling a towable habitat using electric motors, according to the present invention, include providing, by the power management protocol, independent torque commands to each unique electric motor based on a towing vehicle capability or category. The controller and one or more power management protocols can also provide independent torque commands to each unique electric motor based on a distance to destination input.

The method for propelling a towable habitat using electric motors also includes designating, by a user a residual power of the power source at destination requirement. And indeed, the power management protocol can be configured to provide independent torque commands to each unique electric motor based on a rate of power drain of the power source or be configured to modify each unique electric motor between a torque generation mode and a regenerative mode based on an elevation gain or loss over a prescribed travel route as determined by the geo-positional data and a residual power at destination requirement.

In another embodiment of the present invention the method for propelling a towable habitat using electric motors includes sensing by the at least one sensor, geo-positional data and configuring the power management protocol to provide independent torque commands to each unique electric motor based on an elevation gain or loss over a prescribed travel route as determined by the geo-positional data. The methodology can also include gathering sensor data such as to forces generated between the towable habitat and towing vehicle and positional data between the towable habitat and towing vehicle. Using such information, the controller can provide independent torque commands to each unique electric motor limiting positional/force data deviations. These and other features of the present invention are described hereafter.

The features and advantages described in this disclosure and in the following detailed description are not all-inclusive. Many additional features and advantages will be apparent to one of ordinary skill in the relevant art in view of the drawings, specification, and claims hereof. Moreover, it should be noted that the language used in the specification has been principally selected for readability and instructional purposes and may not have been selected to delineate or circumscribe the inventive subject matter; reference to the claims is necessary to determine such inventive subject matter.

### BRIEF DESCRIPTION OF THE DRAWINGS

The aforementioned and other features and objects of the present invention and the manner of attaining them will become more apparent, and the invention itself will be best understood, by reference to the following description of one or more embodiments taken in conjunction with the accompanying drawings, wherein:

FIG. 1 presents a high-level depiction of an electrically powered towable habitat according to one embodiment of the present invention.

FIG. 2 provides a depiction of a high-level system diagram for a powered towable habitat according to one embodiment of the present invention.

FIG. 3 presents a high-level depiction of one configuration of a dual motor drive with a gearbox interposed between the motors and the wheels according to one embodiment of the present invention.

FIGS. 4A and 4B present depictions of a towable habitat frame configured to support the weight of the towable habitat incorporating electric motors and a power source according to one embodiment of the present invention.

FIG. 5 shows a high-level block diagram of a system architecture of an electrically powered towable habitat according to one embodiment of the present invention.

FIG. 6 shows a communication and data flow schematic for operations of an electrically powered towable habitat according to one embodiment of the present invention.

FIG. 7 presents a flowchart of a representative implementation of one or more power management protocols implemented by the electrically powered towable habitat according to one embodiment of the present invention.

FIG. 8 provides additional details on how the process of selecting a power management protocol interacts with sensory data.

FIG. 9 provides additional details on how the process of selecting a power management protocol interacts with sensory data.

FIG. 10 shows a high-level block diagram of a system architecture for remotely controlling an electrically powered towable habitat according to one embodiment of the present invention.

FIG. 11 is a block diagram of a computer system suitable for implementation of operations of an electrically powered towable habitat according to one embodiment of the present invention.

The Figures depict embodiments of the present invention for purposes of illustration only. Like numbers refer to like elements throughout. In the figures, the sizes of certain lines, layers, components, elements, or features may be exaggerated for clarity. One skilled in the art will readily recognize from the following discussion that alternative embodiments of the structures and methods illustrated herein may be employed without departing from the principles of the invention described herein.

### DESCRIPTION OF THE INVENTION

The electrically powered mobile towable habitat of the present invention relies on an electric drivetrain, onboard sensors, a controller, and a receiver hitch that connects an electrically powered towable habitat to the tow vehicle. The receiver hitch, in one embodiment, acts, when working with the controller, to guide the towable habitat to follow the tow vehicle by directly powering the towable habitat wheels while also serving as a fail-safe mechanism for emergency stopping and steering should the towable's onboard steering and braking systems encounter a problem. The present invention allows the towable habitat to couple to the tow vehicle via the receiver hitch or the like, while being self-propelled and self-guided, so that loads on the tow vehicle are optimized and, in some cases, reduced to effectively zero. Features of the present invention are configured so that the presence of the towable habitat is nearly imperceptible from the perspective of tow vehicle performance. The driver of the tow vehicle drives as normal, and the towable habitat keeps up: steering, accelerating, and slowing the towable habitat as required to follow the tow vehicle. The receiver hitch, in one embodiment, includes a flexible zone, a range of motion aft of the tow vehicle wherein the receiver hitch can flexibly increase or decrease length to minimize forces on the tow vehicle during accelerations while simultaneously recognizing movement of the tow vehicle. In one version of the present invention the receiver hitch includes a neutral position that represents the normal towing position of the towable habitat and a damper. A damper functions to resist receiver hitch flex as it deviates from neutral, and to return the receiver hitch to its neutral position, when possible, to facilitate seamless following of the tow vehicle.

Electric motors on the towable habitat are controlled through a combination of electronic control systems/controller, sensors, and power management protocols. The control mechanisms are designed to manage the power supplied to the electric motors thereby controlling torque delivered to each wheel and control wheel speed while ensuring efficient and safe operation.

The controller is a computer or similar system that processes data and executes control algorithms including power management protocols. The controller receives input from various sensors and user commands, processes data based on received data and select power management protocols, and generates appropriate output signals to control, among other things, the electric motors. The controller considers a wide variety of factors including characteristics and factors affecting the tow vehicle, towable habitat attributes, environmental considerations, and inputs regarding the route of travel and desired outcomes.

Embodiments of the present invention are hereafter described in detail with reference to the accompanying Figures. Although the invention has been described and illustrated with a certain degree of particularity, it is understood that the present disclosure has been made only by way of example and that numerous changes in the combination and arrangement of parts can be resorted to by those skilled in the art without departing from the spirit and scope of the invention.

The following description with reference to the accompanying drawings is provided to assist in a comprehensive understanding of exemplary embodiments of the present invention as defined by the claims and their equivalents. It includes various specific details to assist in that understanding, but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

By the term “motor” it is meant a single electric machine that can be used as an electric motor or a generator, converting between electrical power and mechanical power.

By the term “towable habitat” it is meant a wheeled vehicle used as mobile living quarters including as an auxiliary dwelling unit, as a mobile office space, or as a recreational vehicle used for vacation, that contains beds, cooking equipment and the like. Referred to herein generically as a “towable”. In each case the towable habitat can be pulled by a car or similar vehicle.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

The terminology used herein is for the purpose of describing embodiments only and is not intended to be limiting of the invention. As used herein, the singular forms “a,” “an” and “the” are intended to include the plural forms as well, unless the context clearly indicates otherwise. Thus, for example, reference to “a component surface” includes reference to one or more of such surfaces.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

It will be also understood that when an element is referred to as being “on,” “attached” to, “connected” to, “coupled” with, “contacting”, “mounted” etc., another element, it can be directly on, attached to, connected to, coupled with, or contacting the other element or intervening elements may also be present. In contrast, when an element is referred to as being, for example, “directly on,” “directly attached” to, “directly connected” to, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

Spatially relative terms, such as “under,” “below,” “lower,” “over,” “upper” and the like, may be used herein for ease of description to describe one element or feature's relationship to another element(s) or feature(s) as illustrated in the figures. It will be understood that the spatially relative terms are intended to encompass different orientations of a device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of “over” and “under”. The device may be otherwise oriented (rotated 90 degrees or at other orientations) and the spatially relative descriptors used herein interpreted accordingly. Similarly, the terms “upwardly,” “downwardly,” “vertical,” “horizontal” and the like are used herein for the purpose of explanation only unless specifically indicated otherwise.

Included in the description are flowcharts depicting examples of the methodology which may be used to propel a towable habitat using electric motors. In the following description, it will be understood that one or more blocks of the flowchart illustrations, and combinations of blocks in the flowchart illustrations, can be implemented by computer program instructions. These computer program instructions may be loaded onto a computer or other programmable apparatus to produce a machine such that the instructions that execute on the computer or other programmable apparatus create means for implementing the functions specified in the flowchart block or blocks. These computer program instructions may also be stored in a computer-readable memory that can direct a computer or other programmable apparatus to function in a particular manner such that the instructions stored in the computer-readable memory produce an article of manufacture including instruction means that implement the function specified in the flowchart block or blocks. The computer program instructions may also be loaded onto a computer or other programmable apparatus to cause a series of operational steps to be performed in the computer or on the other programmable apparatus to produce a computer implemented process such that the instructions that execute on the computer or other programmable apparatus provide steps for implementing the functions specified in the flowchart block or blocks.

Accordingly, blocks of the flowchart illustrations support combinations of means for performing the specified functions and combinations of steps for performing the specified functions. It will also be understood that each block of the flowchart illustrations, and combinations of blocks in the flowchart illustrations, can be implemented by special purpose hardware and hardware-based computer systems that perform the specified functions or steps, or combinations of special purpose hardware and computer instructions.

Some portions of this specification are presented in terms of algorithms, protocols, or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” or “protocol” is a self-consistent sequence of operations or similar processing leading to a desired result. In this context, operations involve the manipulation of information elements. Typically, but not necessarily, such elements may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” “words”, or the like. These specific words, however, are merely convenient labels and are to be associated with appropriate information elements.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

It will also be understood by those familiar with the art, that the invention may be embodied in other specific forms without departing from the spirit or essential characteristics thereof. Likewise, the naming and division of the modules, managers, functions, systems, engines, layers, features, attributes, methodologies, and other aspects are not mandatory or significant, and the mechanisms that implement the invention or its features may have different names, divisions, and/or formats. Furthermore, as will be apparent to one of ordinary skill in the relevant art, the modules, managers, functions, systems, engines, layers, features, attributes, methodologies, and other aspects of the invention can be implemented as software, hardware, firmware, or any combination of the three. Of course, wherever a component of the present invention is implemented as software, the component can be implemented as a script, as a standalone program, as part of a larger program, as a plurality of separate scripts and/or programs, as a statically or dynamically linked library, as a kernel loadable module, as a device driver, and/or in every and any other way known now or in the future to those of skill in the art of computer programming. Additionally, the present invention is in no way limited to implementation in any specific programming language, or for any specific operating system or environment. Accordingly, the disclosure of the present invention is intended to be illustrative, but not limiting, of the scope of the invention, which is set forth in the following claims.

Portions of the present invention can be implemented in software. Software programming code which embodies the present invention is typically accessed by a microprocessor from long-term, persistent storage media of some type, such as a flash drive or hard drive. The software programming code may be embodied on any of a variety of known media for use with a data processing system, such as a diskette, hard drive, or the like. The code may be distributed on such media or may be distributed from the memory or storage of one computer system over a network of some type to other computer systems for use by such other systems. Alternatively, the programming code may be embodied in the memory of the device and accessed by a microprocessor using an internal bus. The techniques and methods for embodying software programming code in memory, on physical media, and/or distributing software code via networks are well known and will not be further discussed herein. Alternatively, the programing code may be stored in storage available to a smartphone. One embodiment of the present invention provides programming code embodied in an application that can be executed by a smartphone, tablet computer, or other similar device, that receives as inputs both sensor data and data provided by the user, and that processes the combined data to provide an output that is more advantageous than an output that can be produced with sensor data alone. In another embodiment of the present invention, a smartphone application acts as the user interface to enable input of tow vehicle and planned trip information and provides the configuration of protocols used in the invention to determine the amount of torque applied by the motors to the wheels.

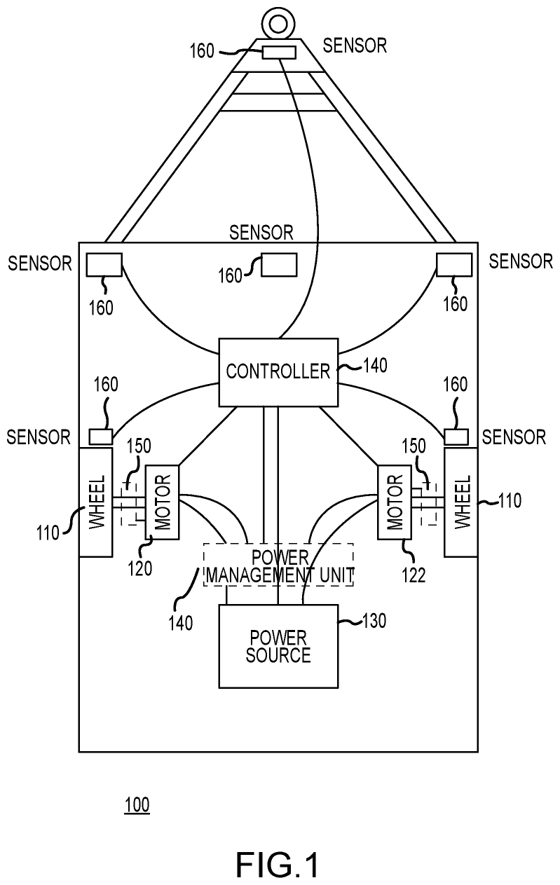

FIG. 1 presents a high-level depiction of an electrically powered towable habitat according to one embodiment of the present invention. The towable habitat 100 of the present invention includes two or more wheels 110 wherein at least one wheel on each side of the towable habitat 100 is associated with a unique electric motor 120, 122. A power source 130 such as a battery or the like, resident on the towable 100, is coupled to each motor 120, 122. In the embodiment shown in FIG. 1, the towable habitat 100 has two wheels 110 with each wheel associated with a separate (unique) electric motor 120, 122. Each motor 120, 122 is connected to a single power source 130. In other embodiments, each motor may be connected to a dedicated power source, or a plurality of power sources (batteries) managed by a separate power management unit. The power management unit 140 is, in this version of the present invention, connected to each electric motor 120, 122, as is the controller 140. In other embodiments of the present invention each motor may be associated with its own power source, each having an individual power management unit. In other versions of the present invention a single dual vector motor can drive two or more wheels through a differential and/or gear box. These and other configurations of a towable habitat drivetrain are contemplated and within the scope of the present invention.

To allow tow vehicle following, the towable habitat in another embodiment has a wheel configuration that supports all four corners of the towable habitat structure to provide a stable base for maneuverability. For longer and heavier versions of the disclosed towable, there may be multiple sets of wheels in the front and/or back of the towable habitat to provide sufficient support for the towable's weight. The wheel system of the present invention is, in one embodiment, attached to a chassis, as is used in the art of electric vehicle design. The chassis includes storage areas for holding a plurality of battery cells as a power source that are electrically connected to two or more electric motors and controlled by the controller. The towable habitat may have a motor for powering a set of two wheels, or each wheel may be powered by its own motor, or a combination of motors may be used.

In another version of the present invention, the towable habitat includes an integrated frame structure that is modular and adaptable. The frame structure in such an embodiment is a metal cage-type design having custom frame rails that are extruded and otherwise configured for optimal strength and stiffness without the use of the typical I-beam and flatbed chassis design used by most existing recreational vehicle towable vehicles. The integrated cage structure creates long joint lines for low concentration load paths, while also providing ready connection points for walls, floor and ceiling panels and other structural elements, and allowing for rapid manufacturing. Through use of the integrated “the box is the beam” frame, the towable habitat allows for internal load carrying rather than relying on external structures. Standardized cross sections and common parts allow modular construction of various models, including shorter models and longer models using common components.

Each electric motor of the present invention, in one embodiment, can provide a predetermined amount of power to its associate wheel or wheels. In an electric motor, the torque and speed relationship is defined by the formula: mechanical power equals the speed multiplied by the torque. The torque and speed relationship is inversely proportional since the rated output power of a motor is a fixed value. The towable's ability to get the wheels into motion, go uphill and accelerate on the highway is dependent on torque produced by each motor. How quickly it can move and the time it takes to travel from one point to another is dependent on speed. A fundamental challenge that all electrically powered vehicles must solve is how much torque and speed are required to fulfill the applications for which the vehicle is designed, since speed and torque are inversely related and the power of the motor(s) is fixed.

In one embodiment of the present invention, motors with sufficient power are used, for example, to accelerate the towable habitat of 5000 lbs. from 0 to 60 mph within 12 seconds and achieve a top speed of 90 mph. Traction of the wheels on a normal surface limits acceleration in this example until approximately 50 mph. Thereafter available power becomes the limiting factor. In such an embodiment a motor of 200 kW is used having a continuous torque of 460 Nm. Using a gearbox having an 8:1 ratio enables the same towable habitat to achieve a top speed of 125 mph. As one of reasonable skill in the relevant art will appreciate, other motor and capacity configuration are possible and are contemplated as being within the scope of the present invention.

According to one embodiment of the present invention, each motor is oversized thereby providing adequate torque and speed to propel the towable habitat under a wide variety of conditions and when associated with a wide variety of tow-vehicles. For example, a towable habitat with oversized motors can easily keep up with a large powerful pickup truck as the towing vehicle as well as mitigate its torque to remain behind a less capable towing vehicle such as a mid-sized sedan. A disadvantage of implementing an oversized motor solution is increased power usage resulting in decreased range. For example, employing a 400 kW motor when a 200 kW motor would have sufficed will comparatively consume more power.

The demand for torque is determined by many factors including acceleration requirements, rolling resistance, aerodynamic drag, and grade resistance (inclination). The towing vehicle is subject to these same factors. Thus, according to one embodiment of the present invention, the protocols controlling the operation of each motor is tied to characteristics/attributes of the towing vehicle and the selected towable habitat profile.

With reference again to FIG. 1, a gearbox 150 is interposed between each motor 120, 122 and its associated wheel 110. The gearbox 150 is used to increase the output torque or to change the speed of a motor. The gearbox is comprised of a series of integrated gears that alter torque and speed between the electric motor and a load, based on gear ratios as directed by the controller. Note that in other embodiments of the present invention a differential can be interposed between a single motor and two or more wheels.

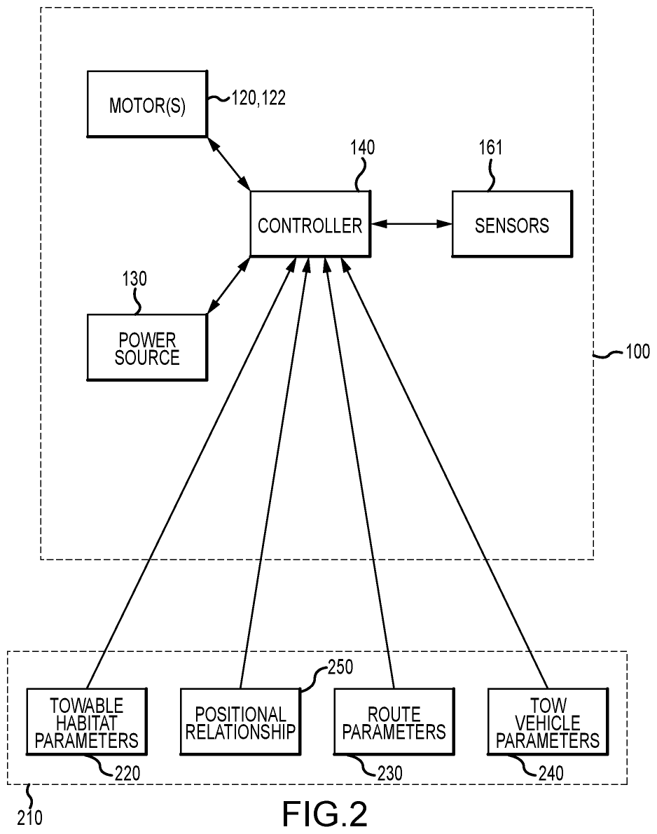

The controller 140 of the present invention receives sensory data from a plurality of sensors 160 and a plurality of parameters, collectively referred to herein as power management protocols. FIG. 2 is a high-level depiction of controller 140 interactions for the power towable habitat of the present invention. The controller 140 resides within the towable habitat 100 along with a power source 130 and one or more electric motors 120, 122. While the controller 140 receives data from each motor 120, 122 and the power source 130, it also analyzes that data in view of other sensor data 168 and a plurality of parameters 210. Those parameters, broadly defined, includes towable habitat parameters 220, route or route of choice parameters 230, tow vehicle parameters 240 and positional (towable habitat to tow vehicle) relationship parameters 250. One or more of these parameters 210 embodying one or more power management protocols drives to controller 190 to issue commands to the motors 120, 122. For example, consider the following configuration of a powered towable habitat according to one embodiment.

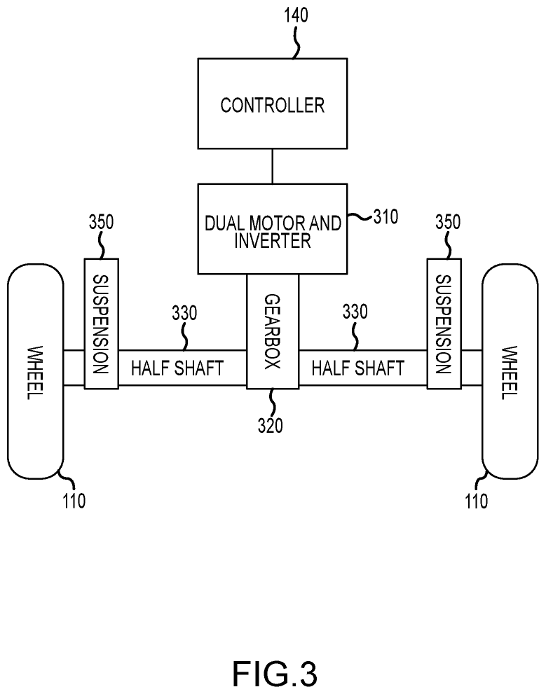

FIG. 3 presents a high-level depiction of one configuration of a dual motor drive with a gearbox interposed between the motors and the wheels. In this version of the present invention a torque vectoring dual electric motor 310 is connected to a common gear box 320. The gearbox 320 is independently coupled to each wheel 110 via a half shaft 330. Each wheel 110 and half shaft 330 are supported by a suspension system 350 connected to the towable habitat frame (not shown).

The controller 140 enables multiple power settings in a single electric motor. The controller evokes an electronic gearbox inside the motor by operating the motor at low speeds with high torque and high speeds with low torque. The result is a balance of torque and speed over a wide range of demands.

Central to motor implementation is the controller. The controller is communicatively coupled to each electric motor. The controller, based on data collected from one or more sensors and certain energy management protocol generates control signals. The signal directs each motor to independently drive its associated wheel, differential, or gearbox. The motor, and a sensor associated with each wheel, provides motor data and wheel speed information back to the controller for analysis.

Similarly, the controller is communicatively coupled to the power source and/or the power management unit. The controller monitors the state of the power source and drain (rate) of power from the power source by each motor. Using this data along with information regarding select energy management protocols, the controller can modify motor control commands.

Sensors are crucial components to the present invention as they provide real-time data to the controller for accurate commands. Sensors can include:
Wheel Sensors: These sensors detect the speed of each wheel and provide data to maintain consistent speed and prevent wheel slippage.
Torque Sensors: Measuring the torque applied to the wheels helps optimize power distribution and prevent overload conditions.
Position Sensors: These sensors determine the position of the towable habitat with respect to the towing vehicle as well as positional information on a select route of travel.
Motion Sensors: These sensors determine movement of the towable habitat in three degrees of freedom; often referred to as an inertial motion (movement) unit.
Inclination/orientation sensor: These sensors measure the orientation on the towable habitat relative to a geostationary plane.
Battery Sensors: Monitoring battery status, voltage, current, and state of charge to manage power distribution effectively.
Load sensors: Measuring forces between the towing vehicle and the towable habitat as well as stresses and strains/movement of individual components of the towable.
Solar Power: measuring rate of solar energy being added to the system if solar is available.

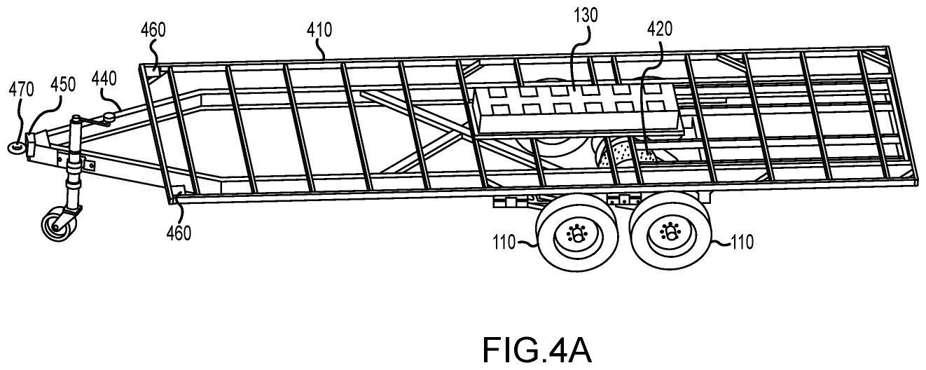

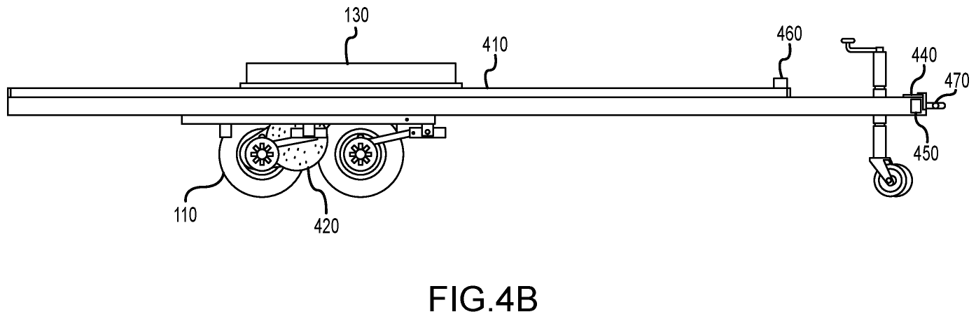

The towable habitat of the present invention is comprised of four primary components. As an illustration of one embodiment of the present invention, FIGS. 4A and 4B present a depiction of a towable habitat frame 410 configured to support the weight of the towable habitat (not shown) comprising four wheels 110, wherein two of the four wheels, one on each side, are with associated with a unique electric motor 420 that allows each to receive power independently.

The depiction of the towable habitat also includes the hitch assembly 440 as part of the towable habitat frame, positioned at the front of the towable, configured to couple the towable habitat to a towing vehicle, and to gather sensor data from at least one sensor 450.

This depiction of the towable habitat includes multiple sensors. Depicted are a load sensor 450, wherein the data are forces generated between the towable habitat and towing vehicle; an optical sensor 460 wherein the sensor data are positional data between the towable habitat and towing vehicle; and a datum movement sensor 470 wherein the data are deviations measurements of movement between the towable habitat and towing vehicle). Based on this data, the hitch assembly 440 provides sensory data such that the controller (not shown) can direct power as needed to each unique motor by a power source 130.

The power source 130 is also pictured on the towable, is centered above the wheels, which provides electrical power to the electric motor 420. Lastly, the towable habitat coupled to the frame 410, includes a controller linked to each unique electric motor and each sensor.

The controller receives sensor data and generates independent torque commands for each unique electric motor based on sensor data and one or more power management protocols.

In some embodiments, the towable habitat of the present invention needs only minimal tow vehicle information to perform tow vehicle following. For example, the towable habitat may use only brake light information gathered by an optical sensor to determine when the tow vehicle is braking. Otherwise, the towable habitat performs its following function based solely on internal sensors. For example, accelerometers or strain gauges mounted in the hitch sense when the tow vehicle is pulling the receiver hitch with a given acceleration or load or that the momentum of the towable habitat is pushing on the hitch as the vehicles slows. In another version of the present invention cameras and/or motion sensors mounted on the towable habitat can sense the tow vehicle a few feet in front of the towable, and observe the tow vehicle slowing, turning, speeding up, and making other maneuvers, while maintaining a certain degree of separation. The sensors can determine changes in relative position of the tow vehicle with respect to the towable habitat and/or movement relatively between the towable habitat and the tow vehicle. Either or both can be used by the controller to manage towable habitat movement. The towable habitat uses the sensors to follow the tow vehicle and to execute one or more of various performance profiles that are selected based on the tow vehicle, the power availability enroute, the distance to the destination, the elevation gain to the destination, or any number of other relevant factors.

Each sensor is configured to collect data with respect to the towable habitat and/or the towing vehicle and/or the environment in which it is operating. Sensors can also be configured to collect data not only with respect to the physical association but also the dynamic relationship between the towable habitat and towing vehicle. Sensors can include optical sensors, LIDAR, UWB, strain gages, or displacement meters and the like.

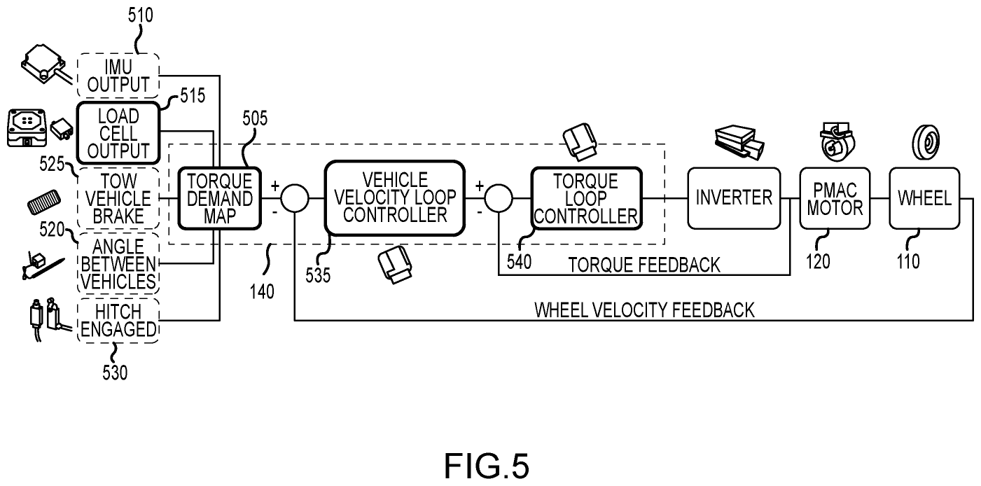

FIG. 5 illustrates one embodiment of a system architecture for acceleration augmentation of an electrically powered towable habitat. As shown in FIG. 5, the controller includes a torque demand map system 505, wherein the power management protocol generates independent torque commands for each unique electric motor based on the sensor data, towing vehicle category, and control parameters. As the towable habitat continuously receives real time data, it adjusts the torque demand accordingly based on motor and towable habitat performance.

The feedback loop pictured demonstrates how the torque demand map 505 of the towable habitat uses the data it receives from an IMU 510, a load cell 515, tow vehicle brake data 525, hitch engagement information, 530 and information regarding the angle between the vehicles 520 and the like, to output controls to the towable habitat braking system and motors.

The controller 140 also includes the vehicle velocity loop controller system 535, wherein the towable habitat uses the data from the torque demand map 505, including geo-positional data, elevation gain and inclination, and power capacity to configure the power management protocol to control power usage and torque commands.

The feedback loop pictured as the vehicle velocity loop controller 535 demonstrates how the towable habitat uses the power management protocol to provide independent torque commands to each unique electric motor based on the continual feedback from the sensors, indicative of the towable habitat inclination and weight in conjunction with wheel speed.

The controller also includes the torque loop controller 540, wherein the towable habitat uses data from the torque demand map 505 and vehicle velocity loop controller 540 to continually, among other things, monitor power capacity, towable habitat speed, inclination, and location of the towable.

The data loop pictured as the torque loop controller 540 demonstrates how the power management protocol determines how to assist the towable's acceleration supplying power to the motor 120 to a predetermined speed sensed from the wheels 110, assist the towable habitat during climbs with an inclination greater than a predetermined angle, and regenerates power during descents during a predetermined declination angle.

In another embodiment of the present invention the hitch assembly includes a sensor configure to measure loads experienced by the towable habitat/hitch because of movement by the towing vehicle. As the towing vehicle changes its position, a load is placed on the hitch assembly. The load sensor recognizes/measures the forces imparted on the hitch assembly in three degrees of freedom and sends sensor data, in this cases force data, to the controller for analysis. In another embodiment of the present invention sensors are incorporated into the towable habitat structure to measure flexure of the towable habitat frame rather than the hitch and impart that information to the controller. In one embodiment the controller directs wheel movement to maintain loads within certain ranges.

For example, assume a load sensor associated with the hitch assembly measures a force indicative of forward acceleration by the towing vehicle. The controller would issue commands to each motor to drive the wheels, and thereby the towable habitat, to neutralize or minimize the forces. In one embodiment an energy management protocol directs the controller to limit forces to a first set of predetermined values while another energy management protocol limits forces to a second set of predetermined values. Using different protocols, the user can select a mode of motor assisted augmentation and control power usage. Other types of energy management protocols are further described herein.

The sensors can also measure/identify the position of the towable habitat or movement of the towable habitat relative to the towing vehicle. Using technology such as LIDAR, UWB, or mechanical linkages, precise measurements can be determined with respect to the relationship/position/motion of the towing vehicle and the towable. In one version of the present invention the hitch assembly provides for a certain degree of translation, laterally and longitudinally, between the towable habitat and the towing vehicle. While physically coupled to the towing vehicle, the hitch assembly nonetheless is displaced by towing vehicle movement. The movement is measured and data regarding the displacement is conveyed to the controller. The sensed data is again analyzed with certain energy management protocols to drive the motors/wheels to return the towable habitat within a predetermined tailer/towing vehicle relationship.

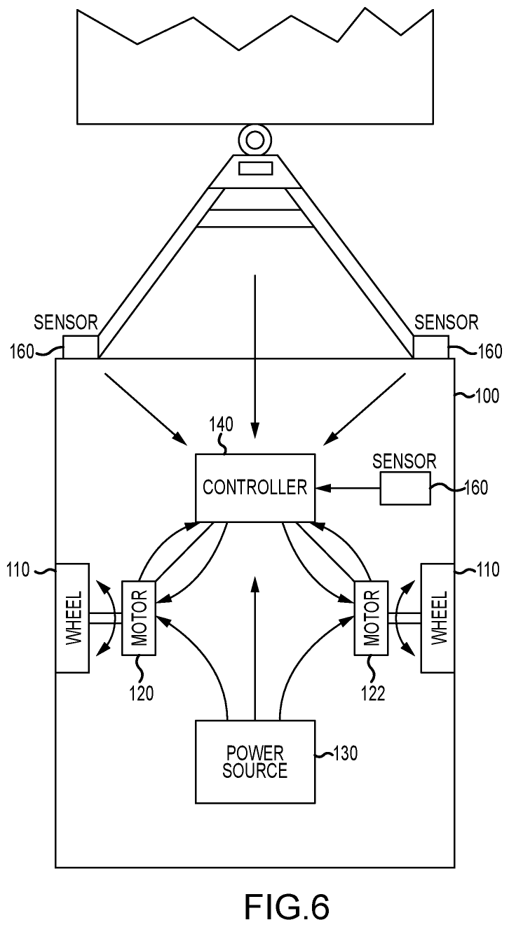

FIG. 6 provides a communication or data flow schematic of an electrically powered towable habitat according to one embodiment of the present invention. The controller 140 is the central gathering point for data collected by sensors 160 as well as issuing commands directing performance of each motor 120, 122. Each sensor 160 autonomously and periodically reports sensory data to the controller 140. This data may be with respect to loads between the towable habitat and the towing vehicle or relative positional information about the towable's position with respect to the towing vehicle. Other sensors measure the inclination of the towable habitat with respect to hill and uneven terrain. In other embodiments an inertial measuring unit measures movement of the towable habitat independent of the towing vehicle. In yet another embodiment, a GPS receiver provides geo-spatial information with respect to the location of the towable habitat as well as current or forthcoming road environments. A wide variety of sensor data is contemplated by and within the scope of the present invention.

The controller 140 is communicatively coupled to each motor 120, 122 for issuing commands driving the wheels 110 and confirming performance of same. The controller 140 receives data from a wheel 110 sensor to confirm that the directives issued to a motor 120, 122 are resulting in the desired wheel rotation. The data is fed back to the controller and commands are modified to produce the desired result. In another embodiment the controller 140 directs a gearbox or similar device to modify motor output to the desired wheel performance.

The controller 140 further receives information from the power source 130 regarding the state of the power source, power remaining, power usage rate, and the like. The controller 140 combines this data to determine which commands should be issued to which motor 120, 122 to achieve a desired result. The desired result, however, varies based on several factors.

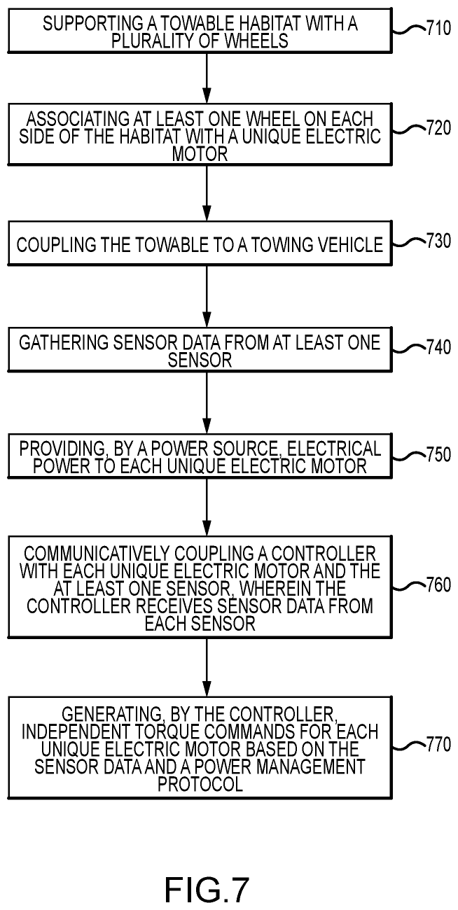

FIG. 7 presents a high-level flowchart of a method for propelling a towable habitat using electric motors. The process begins with supporting 710 a towable habitat by a plurality of wheels and associating 720, in this case, each wheel with its own unique electric motor. In other embodiments of the present invention each wheel may be associated with two or more electric motors or include a gearbox/differential interposed between the motor(s) and the wheel.

The process continues by coupling 730 the towable habitat to a towing vehicle. The physical coupling between the towing vehicle is typically a ball and receiver configuration. Other couplings between a towing vehicle and a towable habitat are equally compatible with the embodiments presented herein as would be known to one of ordinary skill in the relevant art. Each are contemplated and are deemed within the scope of the present invention.

Sensors gather data 740, among other things, regarding the relationship between the towable habitat and the towing vehicle as well performance of the motors, wheel speed, and power source capacity/performance. Power is provided 750 to each electric motor from a power source within the towable via torque commands sent 770 to each motor. In one embodiment the power source may be a battery or series of batteries having a storage capacity sufficient for sustained operation of the motors present on the towable. The power source may be augmented by photovoltaic cells or other external power generation systems.

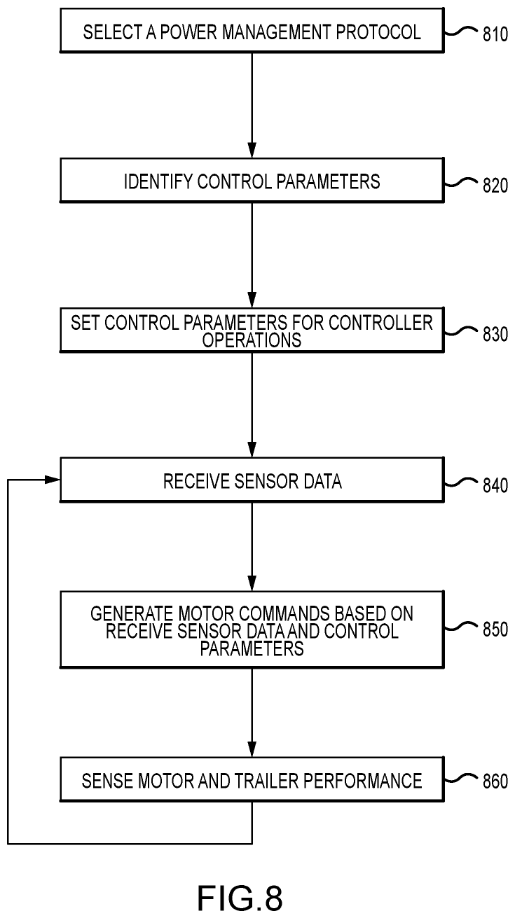

As mentioned above, commands generated 770 by the controller are based on received 760 sensor data and a power management protocol. FIG. 8 provides additional details on how the process of selecting a power management protocol interacts with sensory data. According to one embodiment of the present invention a power management protocol is selected 810 based on a variety of factors. The selected protocol identifies control parameters 820 which set 830 controller operations. As the controller receives 840 sensory inputs, motor commands are generated 850 compliant with both sensory inputs and the control parameters for the selected power management protocol. Lastly the system measures 860 performance and feeds back information to the controller to continuously adjust motor commands during a trip.

In one version of the present invention a plurality of predetermined protocols are provided for user selection. For example, a protocol may be established to provide maximum assistance during acceleration of the towable habitat from zero to 30 mph but thereafter only provide minimal assistance. Alternatively, another protocol may identify a range of travel and a residual power level. For example, a power management protocol may exist stating that the estimated travel distance is 200 miles with a desired residual power capacity at arrival of 50%. Using this protocol, the controller would meter power consumption during the trip to travel 200 miles with 50% power capacity remaining at the destination.

As mentioned above, in one embodiment of the present invention a user may select a destination residual power level. For example, a user may select a residual power level of less than 10% full power or, in a different scenario, greater than 90% power remaining.

Other values are available for selection by the user and are contemplated. The present invention enables a user to modify power consumption used to aid in propelling the towable habitat with needs of power at the destination. In one instance a user may desire that the towable habitat power supply be nearly fully charged as it may be unlikely that any additional power source at the destination is available. Alternatively, the user may opt for maximum use of available power to aid in movement of the towable habitat recognizing that the power supply will be substantially depleted upon arrival.

According to another embodiment of the present invention, the power management protocol can identify control parameters based on different sensory data inputs. For example, another selectable power management protocol directs power to be used to propel the towable habitat when a certain degree of inclination is detected. Using a sensor that measures inclination of the towable habitat as it travels, the controller directs the motors to assist the towing vehicle pulling the towable habitat when a hill is encountered. The degree of inclination upon which the controller begins to issue commands to the motors can be preset or input by a user. For example, assume that one power management protocol identifies that upon recognition that the towable habitat is going up a hill with an inclination greater than 2 degrees, power should be applied to wheels to assist the towing vehicle. In another embodiment the power management protocol can indicate that the controller should assist the towing vehicle in all instances except with the inclination is less or equal to −1 degree of inclination. That is to say, the controller will assist the towing vehicle in all cases except when the towable habitat is going down a hill with an inclination greater than −1 degree. Various preset parameter can be established as energy utilization protocols.

In another embodiment of the present invention a category of towing vehicle may be set thereby determining control parameters used by the controller in generation of commands to the motors. As one of reasonable skill in the relevant art will recognize, all towing vehicles are not created equal. The capability of a towing vehicle may be used to determine the degree of assistance that is required by the electrically powered towable habitat of the present invention. In one embodiment of the present invention one of a plurality of towing vehicle categories are selectable by a user to control controller performance. In one instance the electrically powered towable habitat of the present invention may have predefined towing vehicle categories of small, medium, and large. A small towing vehicle may be a compact car with less than 150 hp. A medium towing vehicle may be a sedan, SUV, or light truck with a power rating between 150 hp and 300 hp. And lastly a large towing vehicle may possess greater than 300 hp. One of reasonable skill in the art will recognize that other factors may drive towing vehicle categorization including weight, braking capacity, cooling capacity for fuel powered vehicles, battery capacity for electric vehicles, traction, and the like. Other tow vehicle parameters can include vehicle weight, draft coefficient, power capacity, fuel capacity (fossil fuel or electric power) and structure limits. In other embodiments data with respect to a tow vehicle can be input via a VIN or make and model information. In yet another embodiment the towable habitat communicates directly with the tow vehicle to gain vehicle capacity information.

For example, assume a small sedan desires to pull an electrically powered towable habitat of the present invention. After coupling the towable habitat to the vehicle, the energy utilization protocol can be set to a small towing vehicle. As sensory data is received from the sensor located throughout the towable habitat and hitch assembly the controller can generate commands to the motor to assist the towing vehicle in moving the towable habitat based on a small tow vehicle. These commands are likely different had the tow vehicle been designated as large. In situations in which the towable habitat is equipped with a hitch load sensor, the generation of commands to the wheels by the controller may be initiated with tighter tolerances at the expense of higher, albeit less efficient, power consumption. Once the towing vehicle has been identified, commands generated by the controller may be modified to optimize power consumption resulting in longer endurance and efficiency.

In another example, the tow vehicle may be a large pickup truck with ample power to pull the towable. In this example, the present invention limits its ability to augment the tow vehicle's acceleration, but instead performs power management of its onboard batteries to ensure they maintain as much energy as possible on the way to the destination. In another example, the tow vehicle is traveling 400 miles, and the towable habitat modifies the commands to augment the distance achievable by the tow vehicle to arrive at the destination with minimal battery power to operate safety and cooling systems. Multiple scenarios are possible and contemplated.

In another embodiment of the present invention the electrically powered towable habitat energy utilization protocol can consider a route of travel. Using information from maps and other sources, a route of travel from a starting point to the destination can be communicated to the controller. Route parameters considered by the present invention can include, among other things, distance, elevation, road type, surface type including road friction considerations, intermediate stops, refueling/charging stops, towing speeds, and atmospherics such as weather forecasts (rain/snow) and wind speed and direction, the energy state of the towable habitat upon arrival at the destination. Upon initiation, the controller can consider the measured weight of the towable habitat along with altitude gain or loss and various hills and descents during the trip. Knowing the likely demands to be placed on the towable habitat to assist the towing vehicle during the trip, the controller can survey available power from the power source and manage power consumption during the excursion.

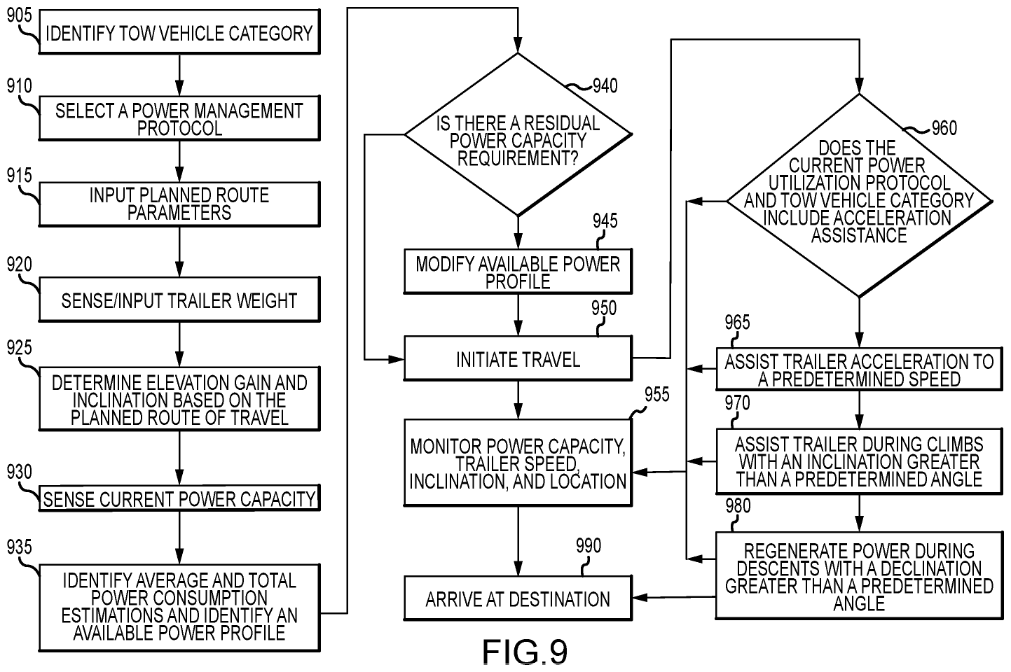

For example, and with reference to FIG. 9, a trip may begin with city driving involving numerous stops and starts, a session of highway travel that includes a significant climb to a higher elevation followed by an extended downhill section, and end with a short section of unimproved roads to the destination. Recognizing the type of environment that the towable habitat is likely to encounter enables the controller to manage power consumption and generate commands to the wheels knowing what is likely to come in the next section or sections of travel. In this instance the controller may assist the towing vehicle to overcome inertia during traffic starts but retain power to aid in the climbing of the hill. Knowing that following the climb a downhill portion will exist during which the motors can be used in a regenerative mode as initiated by the torque control module to add power back to the power source, the controller can aggressively aid the towing vehicle during the climb. It will be appreciated that torque control can be positive or negative. As used in the present invention, positive torque control uses power to place torque on the wheel whereas negative torque uses the wheel to drive the motor thereby generating power to be added back to the power source. Lastly the controller can reserve a portion of the power source capacity for assistance during travel over unimproved roads as traction of both the towing vehicle and the wheels of the towable habitat may be compromised.

The trip begins with identifying 905 a tow vehicle category and selection 910 of a power management protocol. In each case predetermined vehicle categories can be established by the manufacture of the towable habitat or can be set by the user to match the user's vehicle. The route of travel including a starting point and destination is added 915 to enable the towable habitat to determine a likely route of travel so that elevation gain/loss can be ascertained 925 as can a degree of inclination or declination. Lastly the weight 920 of the towable habitat and current power capacity/level 930, in this embodiment, is sensed.

Using this information, the controller determines 935 an estimate average and total power consumption levels and rates to execute the route forming a power consumption plan, thereby determining available power and a target residual power upon arrival at the destination.

If there is a required level of residual power 940 and the current planned power use fails to meet that requirement modifications 945 are made to the power consumption plan. With the plan established, travel is initiated 950. In this example the power management protocol and vehicle category input into the control seeks to assist the towing vehicle with acceleration. One of reasonable skill in the art will recognize that other requirements can be levied on controller based on the selected protocols.

Throughout this process, power capacity and usage rates are monitored 955 so that the commands 960 to the wheels to assist in acceleration 965 or climbing 970, or even power generation 980, meets the requirement to arrive, in this instance, at the destination 990 with an identified level of residual power.

As described herein, another feature of the present invention is to enable the motors to operate in a regenerative or negative torque mode of operation. During descents or in a mode in which the towing vehicle has excess capacity, the controller can modify the motor to a mode of operation in which the motor becomes a generator to restore power to the power source. As different towing vehicles have different capacity, the power management protocol may be used to determine when and/or how frequently the controller switches the motors to generate power rather than consume power.

In another embodiment, the tow vehicle is also an electric vehicle and the towable habitat is in electronic communication with the tow vehicle. In such scenarios, the towable habitat and tow vehicle actively and dynamically collaborate to achieve a desired power management outcome, whether it be minimal travel time, minimum recharge stops, maximum battery power left at destination, etc.

One version of the present invention uses onboard sensors in conjunction with a software application suitable for operation on a phone or tablet. The towable habitat provides real-time towable habitat dynamic information to the user via a user interface and provides cautions and warnings to the user as applicable. Warnings and Cautions may include the following: “Approaching Critical Lateral Sway Angle,” “Brakes Overheating,” “Axles Overloaded,” “Recommended Tongue Weight Exceeded,” “Power Source Level Low” and other relevant and appropriate warnings and cautions.

### Steerable Self-Parking and Self-Hitching Features

The disclosed towable, having its own drivetrain, battery power source, and onboard sensor suite, can be steered, and controlled separately from the tow vehicle, and is also equipped with a system to allow automatic and/or assisted parking and automatic/assisted hitch connection. As discussed herein, the towable habitat of the present invention is equipped with electric motors associated with each wheel, or a pair of wheels that provide forward and reverse propulsion. Further, the towable habitat can be steered by differential motor actuation on either side of the towable habitat as well as by, in another embodiment, moveable axles. Incorporating a nose wheel that freely casters, the towable habitat can be maneuvered apart from a tow vehicle. In one embodiment, the towable habitat can be controlled by one of the following: a joystick located on the receiver hitch, a portable controller, or a mobile application loaded on a smartphone or tablet.

The joystick version of control is configured so that one person can arm the control system and manipulate the joystick to maneuver the towable habitat as if the joystick represents the movement of the receiver/hitch assembly. The towable habitat hitch (receiver) moves in response to the joystick deflection, moving the hitch (towable) in the direction the joystick is deflected. By deflecting the joystick toward the ball hitch on the tow vehicle, the towable habitat can be maneuvered into position for easy connection. Moving the joystick away from the ball the towable habitat can be repositioned backward left or right for parking or repositioning the towable habitat without use of the towing vehicle. Use of the mobile application functions as other remote-control programs known in the art, for example, by displaying a graphical user interface (GUI) on a touchscreen that appears as a set of four arrows, or a steering wheel that can be activated by the user to move the towable.

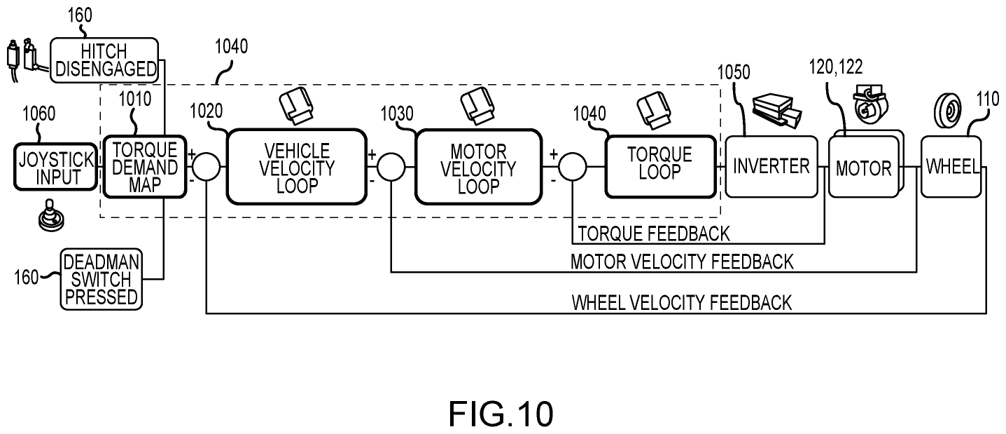

FIG. 10 depicts one embodiment of a system architecture for controlling the movement of an electrically powered towable habitat using a joystick. In this embodiment the controller 140 is comprised of four control modules. They include a torque demand map 1010, a vehicle velocity controller 1020, a motor velocity controller 1030, and a torque controller 1040.

The controller 140 is communicatively coupled to each motor 120, 122 which is thereafter connected to a wheel 110. As described herein, at least one wheel on each side of the towable habitat is associated with one or more motors. Interposed between the motor(s) and the controller is an inverter 1050. Not shown in this architecture is a power source which resides on the towable.

The controller receives information from a plurality of sensors 160. In this embodiment a sensor 160 confirms that the hitch is disengaged and that a deadman switch 160 remains pressed. As one of reasonable skill in the relevant art will recognize the movement of a towable habitat having substantial mass can, if not properly controlled, damage property or inflict injuries on individuals nearby. Accordingly, a deadman switch is included as safety mechanism to ensure that the individual manipulating the towable habitat is fully aware of the surroundings and movement of the towable. Lastly the controller 140 receives input from the joystick 1060 itself. The joystick 1060 can move in any direction and controls vertical movement of the hitch by twisting the stick. The joystick represents the motion of the receiver portion of the hitch. Moving the stick forward or backward results in the tailer moving forward and backward. Governors limit speed but generally the further the stick is displaced the faster the towable, to a limit, moves.

Lateral motion of the stick initiates differential movement of the wheels thereby pivoting the towable. The result is that the hitch moves laterally thereby rotating the towable habitat clockwise or counterclockwise.

Several feedback loops provide information from the inverter 1050, motor 120, 122 and wheels 110 to the torque controller 1040, the motor velocity controller 1030, and the vehicle velocity controller 1020, respectively. Using this type of architecture, the present invention enables a user to maneuver a towable habitat without a tow vehicle.

Different configurations are possible and contemplated, including a joystick controller mounted on the receiver hitch, a controller that can be carried by a user, a controller embedded in a mobile application, or other suitable configuration. The manual controller allows a user to drive the towable habitat into place for easy hookup to the tow vehicle or to park the towable habitat apart from the towing vehicle. Pushing the joystick toward the tow vehicle causes the towable habitat to move in the direction of the tow vehicle. The user could guide the receiver hitch until it is directly over the ball hitch, then twist the joystick counterclockwise to lower the receiver hitch into place on the ball, and then push a button to lock the receiver hitch to the ball. The reverse process allows an easy disconnect from the tow vehicle.

In another example, the user can park the towable habitat apart from the towing vehicle. The user controls speed and direction of towable habitat movement with the controller joystick and guides the towable habitat into place within the lines of a parking space, while being able to walk around the towable habitat to see and clear any obstructions along the route, as convenient. In another example, the controller is embedded in a mobile application. Using the mobile device's GPS location, the application knows where the user, towable, and parking area are located. The application uses the mobile device camera or three-dimensional measuring function to measure the dimensions of the parking area to determine if the towable habitat would fit in the area and could map out obstructions along or above the route. The application may also store previously mapped parking locations, such as a home garage, to park the towable habitat more rapidly in familiar locations. The mobile application may also be configured to access the towable's perimeter monitoring sensors, i.e., cameras, motion sensors, LIDAR, IR, etc., to better determine location and proximity to obstructions while in motion. The manual control may be used in conjunction with the Self-Park feature, wherein the user manually positions the towable habitat close to the parking location, or manually unhooks the towable, then allows the present invention to move the towable habitat into final position.

Another aspect of the disclosed electrically powered towable habitat is a self-parking capability. The self-parking feature (Self-Park) operates, in one embodiment, through use of a mobile application. One embodiment of the present invention uses a camera on a mobile computer, e.g., a smart phone or tablet, and a GPS-enabled navigation application, e.g., Google Maps, to assist the Self-Park along with sensors located on the towable habitat structure. The navigation app is used to mark the boundaries of the towable's parking spot, and the camera is used to map out the environmental features of the parking spot and the route to the spot, such features including nearby trees and buildings, etc. When the spot is plotted and the route and environment are mapped, the Self-Park system of the present invention solves for the towable's drive inputs and moves towable habitat into desired location autonomously.

The disclosed towable habitat also features an automatically connecting and disconnecting receiver hitch (Auto-Hitch) function. The Auto-Hitch has a control system, and uses sensors to include cameras, motion sensors, accelerometers, radiofrequency (RF), microwave, magnetic, light detection and ranging (LIDAR), and/or infrared (IR) to locate the ball hitch of the tow vehicle relative to the location of the towable's receiver hitch. The sensors can be cameras and may be used to triangulate the relative positions optically or can be one or more electromagnetic beacons mounted on the towable habitat or ball to supply relative position information. When engaged, the Auto-Hitch control system uses the towable's electric motors to move the towable habitat into position: the wheels move and steer the towable habitat into the correct location in the fore-aft and left-right directions, while it uses a set of electric jacks to raise or lower the towable habitat so that the receiver hitch is at the correct height to engage the ball hitch. The receiver hitch is also electrically actuated and can open and close upon command from the Auto-Hitch control system. While being towed, the Auto-Hitch also performs a safety function without the requirement of a brake connection with the tow vehicle. If the towable habitat disconnects while the towable habitat and tow vehicle are in motion, the Auto-Hitch can trigger the towable habitat brakes to bring the towable habitat to a halt, or alternatively, can use onboard sensors to slow the towable habitat and steer it to a safe area off the road before coming to a stop.

### Active Anti-Sway & Anti-Tip Systems.

The disclosed towable habitat includes an active anti-sway and dynamic stability system (Anti-Sway) that uses the towable's onboard inertial sensors and or accelerometers along with the towable's electric motors and braking systems to provide stability when the towable habitat is in motion. Depending on the location of the towable's center of gravity (CG), it will be stable while being towed by the tow vehicle. Ideally, the CG will represent a net downward force located forward of the axles and rear of the ball hitch. CG can vary greatly depending on tow speed, which creates aerodynamic drag tending to shift the CG aft. As the CG moves aft, the towable habitat can become unstable and various swaying resonances having increasing amounts of angular momentum can become established resulting in the towable habitat turning over in extreme cases. As a result, existing towable vehicles locate the CG at a conservative 60/40 split, meaning the CG is located 60% of the distance between the axle and the ball hitch. This arrangement tends to increase the tongue weight of the towable, which increases the size and towing capacity of the tow vehicle required to pull a given towable. The Anti-Sway system's inertial sensors and accelerometers identify when the towable habitat is undergoing sway or when the towable habitat becomes otherwise unstable while in motion. Once an undesirable motion is identified, the Anti-Sway system deploys the electric motors on individual or paired wheels, and/or engages the brakes to create acceleration and/or braking modes that dampen the resonant angular momentum and counter the undesired motion. By using the Anti-Sway system, the disclosed towable habitat can establish the CG further aft, reducing tongue weight and reducing the size of the tow vehicle required to pull the towable. The Anti-Sway system can effectively manage the CG-induced instability so that less CG buffer is required.

The towable habitat also includes an anti-tip braking system (Anti-Tip) that uses onboard accelerometers, and IMU and/or inclinometers to sense the approach of the towable's tip over angle and uses the towable's braking system and motors to counter the tipping forces before tipping can occur. For example, if the towable habitat user is towing the towable habitat in the mountains, and the road had increasingly tight turns, the towable habitat could tip over due to the lateral forces on the towable habitat acting above the CG. The towable's Anti-Tip system tracks the CG, and the force multiples of gravity (G's) required to tip the towable habitat at any given CG, this latter value is known as the tipping point. Then the Anti-Tip system uses its onboard accelerometers to determine the G's put on the towable habitat laterally during the turn. The Anti-Tip system uses a set safety margin, wherein if the towable habitat is approaching a tipping point, the system will automatically start braking or using differential commands to the motor to slow the towable habitat down in the turn to reduce lateral G forces places on the towable.

### Sliding Receiver Hitch.

The disclosed towable habitat includes an automatic sliding receiver hitch that functions to minimize the distance between the tow vehicle and the towable habitat in straight line travel to minimize drag. The receiver hitch is dynamically extendable from the towable habitat and includes beams from the towable habitat that attach to the sides of the receiver hitch to transfer a moment into the receiver hitch after the tow vehicle establishes an angle between the towable habitat and the tow vehicle of a certain amount, e.g., 10 degrees, 20 degrees, or 30 degrees, or the like. The moment developed in the turn is used to push the towable habitat aft of the tow vehicle during sharper turns. The distance the sliding receiver hitch moves the towable habitat aft is proportional to the amount of turn out to a set maximum distance. Once the turn is established and often the turn is completed, the sliding receiver hitch will move the towable habitat closer to the tow vehicle to reduce the gap between vehicles thereby reducing drag. Such movement allows the towable habitat to follow the tow vehicle closely during straight travel but provides wider clearance when the tow vehicle needs to execute a tight turn. The sliding receiver hitch thus effectively reduces the combined towable habitat and tow vehicle length, and decreases aerodynamic drag caused by the gap between the tow vehicle and towable. Some embodiments may use a mechanically actuated or assisted sliding receiver hitch. The system is dynamic and modifies the distance between the tow vehicle and towable habitat based on sensed conditions.

In yet another embodiment of the present invention, the towable habitat includes a receiver hitch-stabilizing flywheel. The towable's receiver hitch incorporates a spinning mass gyro flywheel to resist transient dynamic loads on the tow vehicle's ball hitch, e.g., hitting a pothole might cause the receiver hitch to lurch downward, which movement would be resisted and dampened by the gyro mechanism. The flywheel thus aids the towable habitat to follow the tow vehicle seamlessly and allows a lighter tow vehicle to pull a heavier towable habitat because less force is translated to the tow vehicle, which forces left unchecked could cause the vehicle to lose control. Some embodiments include a receiver hitch configured to weigh the towable habitat by measuring the force developed in the receiver hitch over level, paved surfaces. Using the force measurement and assuming normal rolling friction, the receiver hitch calculates the mass of the towable. Some embodiments of the towable habitat include a towable habitat center of gravity determining receiver hitch. The receiver hitch includes sensors that determine hitch weight and calculate the CG envelope for given towable habitat size and other specifications. For example, if a towable habitat of given length has a default CG, with a corresponding tongue weight, the receiver hitch can measure the actual tongue weight and calculate the new CG. towable habitat CG's can vary greatly due to cargo loading, and wind resistance during towing.

The electrically powered recreational tailer of the present invention provides, in one or more embodiments, an electric drivetrain, onboard sensors, a controller with energy management protocols, and a dynamic receiver to redefine the relative role between a towable habitat and a towing vehicle. Rather than a towable habitat being a passive carriage that is dependent on the towing vehicle for all aspects of motion, the electrically powered towable habitat of the present invention manages the use of internal motors associated with one or more wheels along with an internal power source to unencumber the towing vehicle. The receiver hitch, in one embodiment, acts to guide the towable habitat to follow the tow vehicle by directly powering the towable habitat wheels while also serving as a fail-safe mechanism for emergency stopping and steering should the towable's onboard steering and braking systems encounter a problem. The present invention allows the towable habitat to couple to the tow vehicle via the receiver hitch or the like, while being self-propelled and self-guided, so that loads on the tow vehicle are optimized and, in some cases, reduced to effectively zero. Features of the present invention are configured so that the presence of the towable habitat is nearly imperceptible from the perspective of tow vehicle performance.

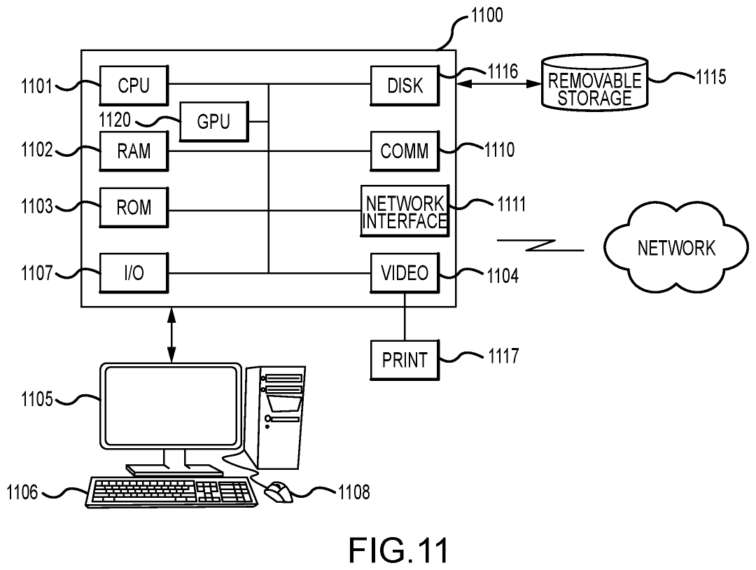

One of reasonable skill will also recognize that portions of the present invention may be implemented on a conventional or general-purpose computing system, such as a personal computer (PC), server, smart phone, tablet, a laptop computer, a notebook computer, or the like. FIG. 11 is a very general block diagram of a computer system in which software-implemented processes of the present invention may be embodied. As shown, system 1100 comprises a central processing unit(s) (CPU) or processor(s) 1101 coupled to a random-access memory (RAM) 1102, a graphics processor unit(s) (GPU) 1120, a read-only memory (ROM) 1103, a keyboard or user interface 1106, a display or video adapter 1104 connected to a display device 1105, a removable (mass) storage device 1115 (e.g., floppy disk, CD-ROM, CD-R, CD-RW, DVD, or the like), a fixed (mass) storage device 1116 (e.g., hard disk), a communication (COMM) port(s) or interface(s) 1110, and a network interface card (NIC) or controller 1111 (e.g., Ethernet, WIFI). Although not shown separately, a real time system clock is included with the system 1100, in a conventional manner.

CPU 1101 comprises a suitable processor for implementing the present invention. The CPU 1101 communicates with other components of the system via a bi-directional system bus 1120 (including any necessary input/output (I/O) controller 1107 circuitry and other “glue” logic). The bus, which includes address lines for addressing system memory, provides data transfer between and among the various components. Random-access memory 1102 serves as the working memory for the CPU 1101. The read-only memory (ROM) 1103 contains the basic input/output system code (BIOS)—a set of low-level routines in the ROM that application programs and the operating systems can use to interact with the hardware, including reading characters from the keyboard, outputting characters to printers, and so forth.

Mass storage devices 1115, 1116 provide persistent storage on fixed and removable media, such as magnetic, optical, or magnetic-optical storage systems, flash memory, or any other available mass storage technology. The mass storage may be shared on a network, or it may be a dedicated mass storage. As shown in FIG. 11, fixed storage 1116 stores a body of program and data for directing operation of the computer system, including an operating system, user application programs, driver, and other support files, as well as other data files of all sorts. Typically, the fixed storage 1116 serves as the main hard disk for the system.

In basic operation, program logic (including that which implements methodology of the present invention described below) is loaded from the removable storage 1115 or fixed storage 1116 into the main (RAM) memory 1102, for execution by the CPU 1101. During operation of the program logic, the system 1100 accepts user input from a keyboard and pointing device 1106, as well as speech-based input from a voice recognition system (not shown). The user interface 1106 permits selection of application programs, entry of keyboard-based input or data, and selection and manipulation of individual data objects displayed on the screen or display device 1105. Likewise, the pointing device 1108, such as a mouse, track ball, pen device, or the like, permits selection and manipulation of objects on the display device. In this manner, these input devices support manual user input for any process running on the system.

The computer system 1100 displays text and/or graphic images and other data on the display device 1105. The video adapter 1104, which is interposed between the display 1105 and the system's bus, drives the display device 1105. The video adapter 1104, which includes video memory accessible to the CPU 1101, provides circuitry that converts pixel data stored in the video memory to a raster signal suitable for use by a cathode ray tube (CRT) raster or liquid crystal display (LCD) monitor. A hard copy of the displayed information, or other information within the system 1100, may be obtained from the printer 1117, or other output device.

The system itself communicates with other devices (e.g., other computers) via the network interface card (NIC) 1111 connected to a network (e.g., Ethernet network, Bluetooth wireless network, or the like). The system 1100 may also communicate with local occasionally connected devices (e.g., serial cable-linked devices) via the communication (COMM) interface 1110, which may include a RS-232 serial port, a Universal Serial Bus (USB) interface, or the like. Devices that will be commonly connected locally to the interface 1110 include laptop computers, handheld organizers, digital cameras, and the like.

While there have been described above the principles of the present invention in conjunction with an electrically powered towable habitat, it is to be clearly understood that the foregoing description is made only by way of example and not as a limitation to the scope of the invention. Particularly, it is recognized that the teachings of the foregoing disclosure will suggest other modifications to those persons skilled in the relevant art. Such modifications may involve other features that are already known per se and which may be used instead of or in addition to features already described herein. Although claims have been formulated in this application to particular combinations of features, it should be understood that the scope of the disclosure herein also includes any novel feature or any novel combination of features disclosed either explicitly or implicitly or any generalization or modification thereof which would be apparent to persons skilled in the relevant art, whether or not such relates to the same invention as presently claimed in any claim and whether or not it mitigates any or all of the same technical problems as confronted by the present invention. The Applicant hereby reserves the right to formulate new claims to such features and/or combinations of such features during the prosecution of the present application or of any further application derived therefrom.

1-24. (canceled)

25. An electric powered towable habitat, comprising:
a frame comprising two or more wheels, wherein at least one wheel is positioned on each side of the frame and where the at least one wheel positioned on each side of the frame is associated with a unique electric motor;
a hitch assembly configured to couple the towable habitat to a towing vehicle;
at least one sensor configured to gather sensor data;
a power source providing electrical power to each said unique electric motor;
a controller communicatively coupled with each unique electric motor; and the at least one sensor, said controller being operatively configured to receive sensor data from each sensor and wherein the controller is further configured to generate independent torque commands for each unique electric motor based on the sensor data and a power management protocol.

26. The electric powered towable habitat of claim 25, wherein the power management protocol is configured to provide independent torque commands to each unique electric motor based on a towing vehicle parameter.

27. The electric powered towable habitat of claim 25, wherein the power management protocol is configured to provide independent torque commands to each unique electric motor based on a towable habitat parameter.

28. The electric powered towable habitat of claim 25, wherein the power management protocol is configured to provide independent torque commands to each unique electric motor based on a route parameter.

29. The electric powered towable habitat of claim 25, wherein the power management protocol is configured to provide independent torque commands to each unique electric motor based on a positional relationship parameter between the towable habitat and the towing vehicle.

30. The electric powered towable habitat of claim 25, wherein the power management protocol is configured to provide independent torque commands to each unique electric motor based on a residual power at destination requirement.

31. The electric powered towable habitat of claim 30, wherein the residual power at destination requirement is the power source having a user designated power level.

32. The electric powered towable habitat of claim 25, wherein the at least one sensor includes geo-positional data and the power management protocol is configured to provide independent torque commands to each unique electric motor based on an elevation gain or loss over a prescribed travel route as determined by the geo-positional data.

33. The electric powered towable habitat of claim 25, wherein the power management protocol is configured to provide independent torque commands to each unique electric motor based on predetermined torque limits.

34. The electric powered towable habitat of claim 25, wherein the power management protocol is configured to provide independent torque commands to each unique electric motor based on sensor data indicative of a towable habitat inclination and a towable habitat weight.

35. The electric powered towable habitat of claim 25, wherein the at least one sensor is an optical sensor and wherein the sensor data provides relative positional data between the towable habitat and a towing vehicle.

36. The electric powered towable habitat of claim 25, wherein the at least one sensor is a datum movement sensor and wherein the sensor data are relative deviations measurements of movement between the towable habitat and a towing vehicle.

37. The electric powered towable habitat of claim 25, wherein the power management protocol is configured to provide independent torque commands to each unique electric motor based on sensor data indicative of a change in towable habitat angular momentum.

38. The electric powered towable habitat of claim 25, wherein the power management protocol is configured to provide independent torque commands to each unique electric motor based on sensor data indicative of a towable habitat inclination and a towable habitat weight.

39. The electric powered towable habitat of claim 25, wherein the power management protocol is configured to modify each unique electric motor to a regenerative mode based on a residual power at destination requirement.

40. The electric powered towable habitat of claim 25, wherein the at least one sensor includes geo-positional data and the power management protocol is configured to modify each unique electric motor between a torque generation mode and a regenerative mode and based on an elevation gain or loss over a prescribed travel route as determined by the geo-positional data and a residual power at destination requirement.

41. A method for propelling a towable habitat using electric motors, comprising:
positioning at least one wheel on each side of the towable habitat;
associating at least one unique electric motor with at least one of the at least one wheel on each side of the habitat;
coupling the towable habitat to a towing vehicle;
gathering sensor data from at least one sensor;
providing, by a power source, electrical power to the at least one unique electric motor;
communicatively coupling a controller with the at least one unique electric motor and the at least one sensor, wherein the controller receives sensor data from each sensor; and
generating, by the controller, independent torque commands for the at least one unique electric motor based on the sensor data and a power management protocol.

42. The method for propelling a towable habitat using electric motors of claim 41, further comprising, providing by the power management protocol independent torque commands to each unique electric motor based on a towing vehicle parameter.

43. The method for propelling a towable habitat using electric motors of claim 41, further comprising, providing by the power management protocol independent torque commands to each unique electric motor based on a route parameter.

44. The method for propelling a towable habitat using electric motors of claim 41, further comprising, providing by the power management protocol independent torque commands to each unique electric motor based on a towing vehicle category.

45. The method for propelling a towable habitat using electric motors of claim 41, further comprising, providing by the power management protocol independent torque commands to each unique electric motor based on a positional relationship parameter between the towable habitat and the towing vehicle.

46. The method for propelling a towable habitat using electric motors of claim 41, further comprising providing, by the controller and the power management protocol, independent torque commands to each unique electric motor based on a distance to destination input.

47. The method for propelling a towable habitat using electric motors of claim 41, further comprising designating, by a user, a residual power of the power source at destination requirement.

48. The method for propelling a towable habitat using electric motors of claim 41, further comprising, sensing by the at least one sensor, geo-positional data and configuring the power management protocol to provide independent torque commands to each unique electric motor based on an elevation gain or loss over a prescribed travel route as determined by the geo-positional data.

49. The method for propelling a towable habitat using electric motors of claim 41, wherein gathering sensor data includes forces generated between the towable habitat and the towing vehicle.

50. The method for propelling a towable habitat using electric motors of claim 41, wherein gathering sensor data includes positional data between the towable habitat and the towing vehicle and wherein generating includes providing independent torque commands to each unique electric motor limiting positional data deviations.

51. The method for propelling a towable habitat using electric motors of claim 41, further comprising configuring the power management protocol to provide independent torque commands to each unique electric motor based on sensor data indicative of a towable habitat inclination and a towable habitat weight.

52. The method for propelling a towable habitat using electric motors of claim 41, further comprising configuring the power management protocol to provide independent torque commands to each unique electric motor based on a rate of power drain of the power source.

53. The method for propelling a towable habitat using electric motors of claim 41, wherein gathering includes geo-positional data and further comprising the power management protocol to modify each unique electric motor between a torque generation mode and a regenerative mode based on an elevation gain or loss over a prescribed travel route as determined by the geo-positional data and a residual power at destination requirement.
